(19) United States
(12) Patent Application Publication
(10) Pub. No.: US 2024/0296322 A1
(43) Pub. Date: Sep. 5, 2024

(54) LEARNED CONVERSION OF MEASUREMENT SOURCES WITH DIFFERENT UNITS

(71) Applicant: International Business Machines Corporation, Armonk, NY (US)

(72) Inventors: Marco Luca Sbodio, Castaheany (IE); Joao H. Bettencourt-Silva, Dublin (IE); Thanh Lam Hoang, Maynooth (IE); Natalia Mulligan, Dublin (IE); Gabriele Picco, Dublin (IE); Marcos Martínez Galindo, Dublin (IE)

(21) Appl. No.: 18/177,208

(22) Filed: Mar. 2, 2023

(51) Int. Cl. G06N 3/08

(52) U.S. Cl. CPC G06N 3/08

(57) ABSTRACT

Aspects of the invention include techniques for automatically converting measurements from measurement sources having different units. A non-limiting example method includes receiving a plurality of data streams. Each data stream is received from a respective data source and includes measurement data. A target data source is selected from the respective data sources and a generative model is pre-trained on the measurement data of the target data stream to estimate a true distribution of the measurement data in a selected unit of measurement. A unit conversion neural network is trained for each non-target data source to convert the measurement data to the selected unit of measurement. The measurement data of a first non-target data source is converted to the selected unit of measurement using the respective trained unit conversion neural network and the converted measurement data is combined with the measurement data of the target data source in a data lake.

### BACKGROUND

The present invention generally relates to data integration and database warehousing, and more specifically, to computer systems, computer-implemented methods, and computer program products for automatically converting measurements from measurement sources having different units.

Database warehousing refers to the use of a centralized repository (often referred to as a data lake) for the storage of an arbitrary scale of structured and unstructured data. The incoming data fed to a data lake can come from a variety of sources. The integration, comparison, and interpretation of the data within a data lake requires, at minimum, that all measurements are represented in the same units. Unfortunately, various standards exist for unit representation, such as the International System of Standards (SI) (e.g., the meter) and the imperial system (e.g., feet). Complicating matters further, the choice in units, even within the same system, can vary significantly (e.g., inches vs. feet vs. miles, etc. for a distance measurement). Finding a consistent methodology for reliably and automatically integrating measurements taken from data sources which use different, often unknown units remains an open problem in database warehousing.

### SUMMARY

Embodiments of the present invention are directed to techniques for automatically converting measurements from measurement sources having different units. A non-limiting example method includes receiving a plurality of data streams. Each data stream is received from a respective data source and includes measurement data. A target data source is selected from the respective data sources and a generative model is pre-trained on the measurement data of the target data stream to estimate a true distribution of the measurement data in a selected unit of measurement. A unit conversion neural network is trained for each non-target data source to convert the measurement data to the selected unit of measurement. The measurement data of a first non-target data source is converted to the selected unit of measurement using the respective trained unit conversion neural network and the converted measurement data is combined with the measurement data of the target data source in a data lake.

Other embodiments of the present invention implement features of the above-described method in computer systems and computer program products.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a block diagram of an example computing environment for use in conjunction with one or more embodiments of the present invention;

FIG. 2 depicts a block diagram of an example distributed records system in accordance with one or more embodiments of the present invention;

FIG. 3 depicts a block diagram of an example training process for a unit conversion module in accordance with one or more embodiments; and

FIG. 4 is a flowchart in accordance with one or more embodiments of the present invention.

The diagrams depicted herein are illustrative. There can be many variations to the diagram or the operations described therein without departing from the spirit of the invention. For instance, the actions can be performed in a differing order or actions can be added, deleted or modified.

In the accompanying figures and following detailed description of the described embodiments of the invention, the various elements illustrated in the figures are provided with two or three-digit reference numbers. With minor exceptions, the leftmost digit(s) of each reference number correspond to the figure in which its element is first illustrated.

### DETAILED DESCRIPTION

Utilizing data (e.g., comparing, interpreting, etc.) within a database requires, at minimum, that all measurements, wherever sourced, be represented in the same units. Data (e.g., measurements) taken in different units must therefore be normalized, typically by converting the various units into a single, consistent unit. Several techniques exist for converting measurements from various sources to the same units, but each comes with its own limitations and tradeoffs. In particular, existing methods require meta data (context data, e.g., data identifiers, units of measurement, etc.) for each measurement to select the most suitable data transformation algorithm from a library. In other words, existing methods need to know the units and the conversion mappings and are limited to the trivial case where that data is readily available. As a result, these systems will inherently require tuning and/or amending every time a new data format or data transformation algorithm is introduced to the system. In addition, these systems have no mechanism for automatically processing previously unseen data formats (i.e., how to integrate data when the units for the data are unknown).

One or more embodiments of the present invention address one or more of the above-described shortcomings by providing computer-implemented methods, computing systems, and computer program products for automatically converting measurements from measurement sources having different, even unknown, units. In some embodiments, a plurality of data is sourced from a plurality of sources (D₁, D₂, . . . , D_{N}). In some embodiments, the data includes a plurality of measurements and only the values of those measurements are known-other data, such as the units of measurements for each respective measurement, the distribution of a respective dataset, etc., are not known.

In some embodiments, a generative model G, such as a Variational AutoEncoder (VAE), is trained to estimate a true distribution G(D)=P(D) of the data in a unit of interest. The model G can be trained generically over the entire dataset, or alternatively, if contextual information identifying two or more sub-populations in the data is known, G can be trained separately for each sub-population to estimate a conditional distribution P(D|z), where z is a contextual category variable. For example, consider a healthcare network of three hospitals (D₁, D₂, D₃) that partitions blood pressure data into three sub-populations (z₁, z₂, z₃), such as Children, Man, and Women, respectively. G can be trained for each sub-population (G(z₁), G(z₂), G(z₃)), to estimate the conditional distribution P(D|z) where z is “Children”, “Man”, or “Women”.

In some embodiments, a target source is selected from the plurality of sources (D₁, D₂, . . . , D_{N}). Continuing with the prior example, the first hospital D₁ can be selected as the target source. The target source can be selected based on any desired factor(s), such as, for example, how representative the data within the respective source is as compared to the overall data set (e.g., a general hospital vs. a children's hospital, etc.), the amount of data available at the respective source, the distribution of that data, etc.

In some embodiments, N−1 conversion functions (C₂, C₃, . . . , C_{N}) are found for each other source (i.e., all other sources other than the selected target source). A conversion function (Cₘ) converts the measurements from a conversion source (Dₘ) to the same units as the measurements in the target source (here, D₁). Notably, the actual units of measurement for both the target source and the conversion source need not be known. In some embodiments, the conversion functions are trained conversion neural networks. In some embodiments, the conversion neural networks are trained to minimize a negative log-likelihood based on whether the combined conversion source data from the non-target sources should follow the same distribution as the target source distribution (e.g., the combined data from an adult hospital and a children's hospital should follow the same distribution as a general hospital) or, alternatively, whether the combined conversion source data from the non-target sources represent only a portion of the target source data (e.g., the combined data from a women's clinic and a children's hospital that excludes male patient data will not follow the same distribution as a general hospital).

Aspects of the present disclosure can automatically harmonize data from a variety of sources, but, unlike prior approaches, can do so without requiring any predetermined data format or representation schema, and without even requiring that the underlying data formats and distributions be known. While generally described in the context of health care data records for ease of illustration and discussion, aspects of the disclosed described herein are not limited to health care records. Notably, automatic unit conversion techniques described herein can be leveraged against any data aggregation task and all such configurations and domains are within the contemplated scope of this disclosure. For example, aspects of the present disclosure can be leveraged in a variety of data management systems, data integration workflows, extract, transform and load (ETL) pipelines, and extract, load, and transform (ELT) patterns.

Advantageously, automatically converting measurements according to one or more embodiments described herein removes the metadata requirements inherent to legacy unit conversion systems. In short, the only “metadata” required for automatic data conversion is the value of the data itself. For example, height measurements taken from three different hospitals (e.g., a general hospital, a children's hospital, and an adult hospital) can be readily co-integrated into a single data format (e.g., inches, centimeters, etc.) even when the units of measurement for the incoming data from these sources and their distributions are unknown. In other words, aspects of the present disclosure operate at the value level, as opposed to the format level.

Embodiments described herein can be used as a standalone system or integrated within (e.g., as a module) existing data transformation schemes to decrease the number of iterations required for unit conversions and to learn data transformations on the fly, without subject matter expert knowledge and without needing to know the unit meta data (e.g. units of measurements of the sources, the distributions of those measurements, etc.).

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

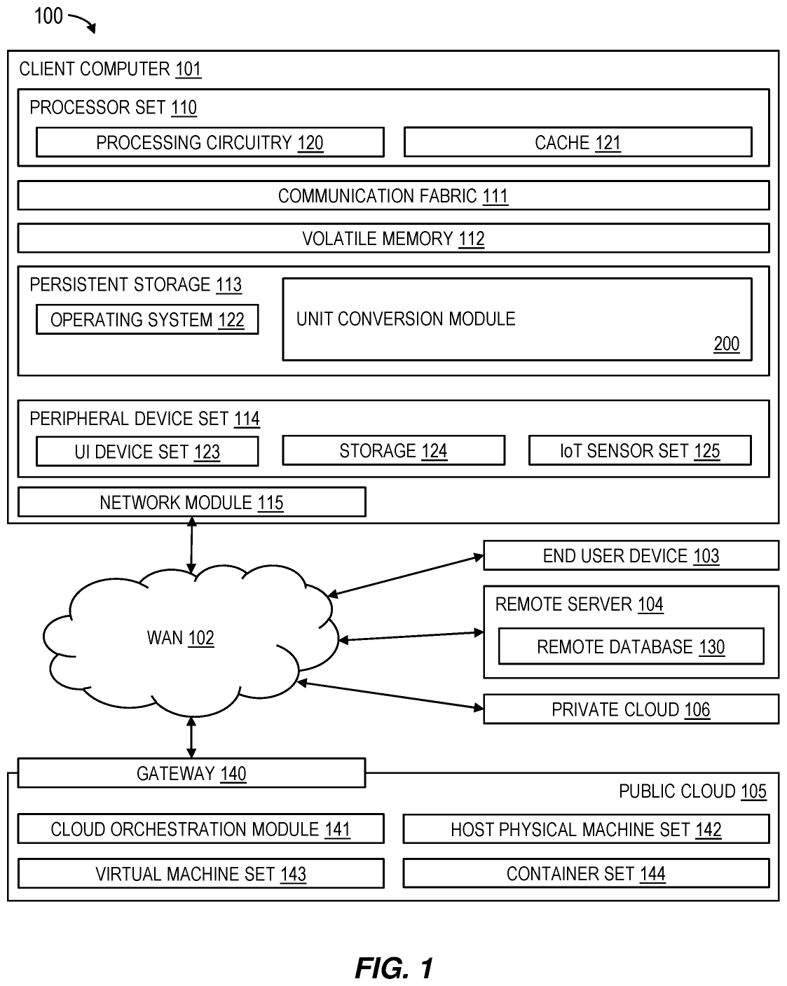

Referring now to FIG. 1, computing environment 100 contains an example of an environment for the execution of at least some of the computer code involved in performing the inventive methods, such as unit conversion module 200 (also referred to herein as block 200). In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

It is to be understood that the block diagram of FIG. 1 is not intended to indicate that the computing environment 100 is to include all of the components shown in FIG. 1. Rather, the computing environment 100 can include any appropriate fewer or additional components not illustrated in FIG. 1 (e.g., additional memory components, embedded controllers, modules, additional network interfaces, etc.). Further, the embodiments described herein with respect to the computing environment 100 may be implemented with any appropriate logic, wherein the logic, as referred to herein, can include any suitable hardware (e.g., a processor, an embedded controller, or an application specific integrated circuit, among others), software (e.g., an application, among others), firmware, or any suitable combination of hardware, software, and firmware, in various embodiments.

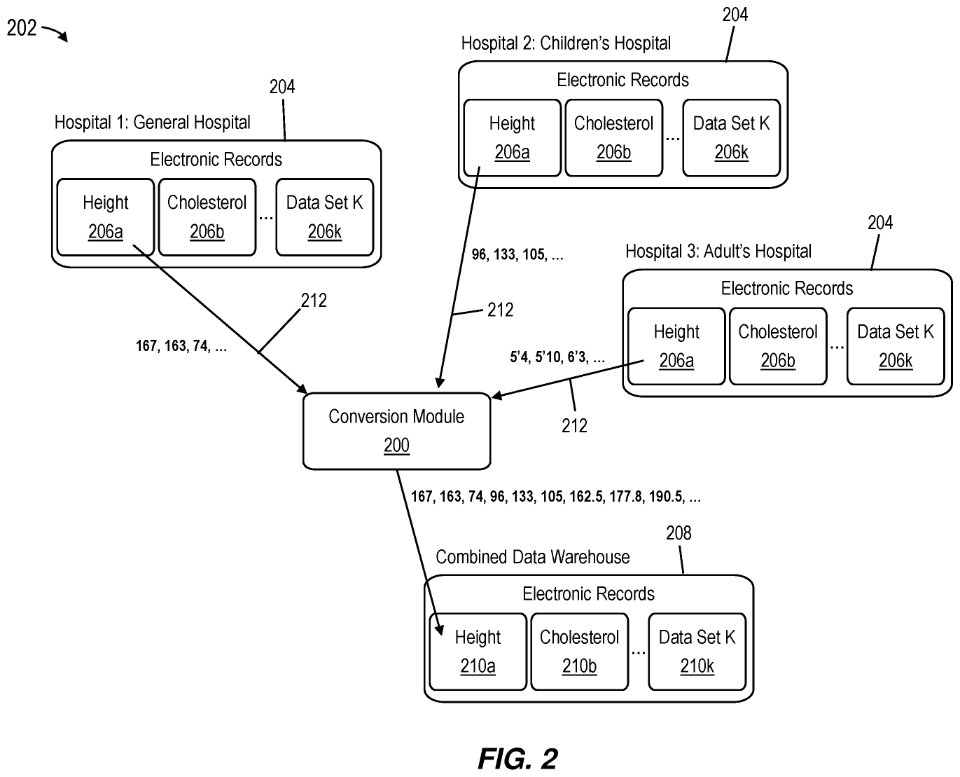

FIG. 2 depicts a block diagram of an example distributed records system 202 in accordance with one or more embodiments of the present invention. The distributed records system 202 can include a plurality of data sources 204 (as shown, “Hospital 1”, “Hospital 2”, and “Hospital 3”). The data sources 204 can be co-located or geographically distributed, depending on the particular application. The particular number and type of data sources 204 is shown for ease of illustration and convenience only and are not meant to be particularly limited. The number and type of data sources 204 can vary, and all such configurations are within the contemplated scope of this disclosure. In some embodiments, each of the data sources 204 maintains an internal record (e.g., “Electronic Records”) of K data sets 206a, 206b, . . . , 206k. For example, the K data sets 206a, 206b, . . . , 206k can include the respective hospital's internal record set of measurements (here, “Height” 206a and “Cholesterol” 206b).

In some embodiments, the various data sources 204 may record the same measurement (e.g., “Height”) in different units (e.g., inches, feet, centimeters, etc.). For example, a general hospital (“Hospital 1”) may record patient heights in feet, while a children's hospital (“Hospital 2”) may record patient heights in inches. Complicating matters further, in some embodiments, the distribution of the respective measurements of each data source of the data sources 204 can differ. For example, due to the nature of each hospital (i.e., a General Hospital, a Children's Hospital, and an Adult's Hospital), the respective measurement distributions for the same measurement (e.g., height) will be different—heights recorded in the Children's Hospital will have a smaller mean than in the General Hospital, etc.

In some embodiments, the distributed records system 202 includes a combined data warehouse 208 (sometimes referred to as a data lake). In some embodiments, the combined data warehouse 208 stores the K data sets 206a, 206b, . . . , 206k from each of the data sources 204 within K combined data sets 210a, 210b, . . . , 210k. In some embodiments, one or more measurements (e.g., Height 206a) must be converted into a single format (e.g., inches, feet, etc.) to achieve a consistent merge within the combined data warehouse 208.

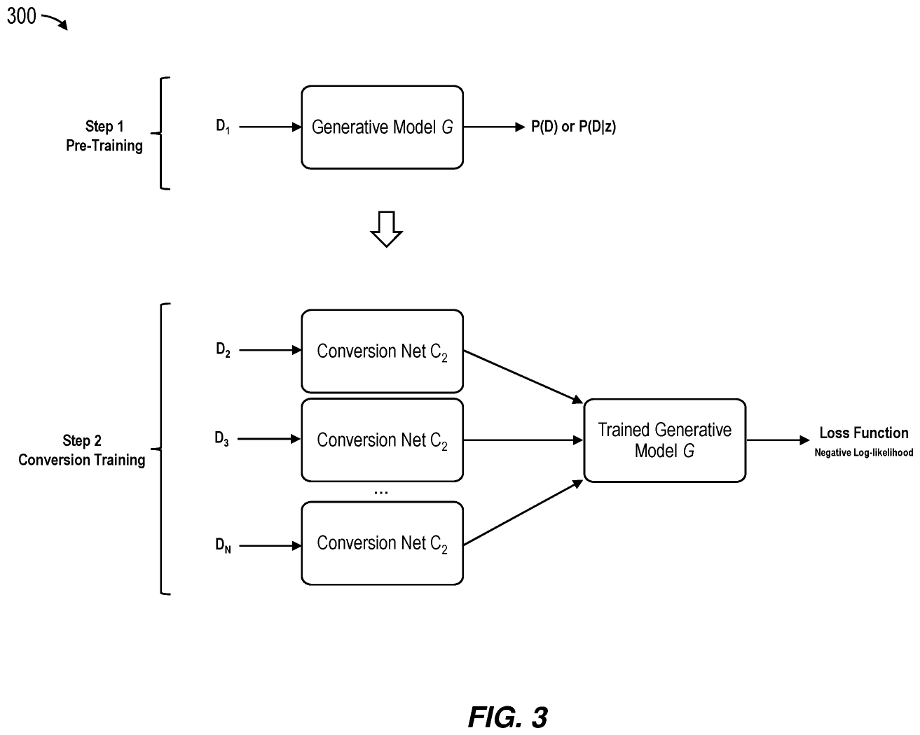

In some embodiments, conversion of the K data sets 206a, 206b, . . . , 206k from each of the data sources 204 into consistent units of measurement is handled by the unit conversion module 200 (refer to FIG. 1). In some embodiments, the unit conversion module 200 only receives numerical data streams 212 (e.g., 167, 163, 74 from the General Hospital, 96, 133, 105 from the Children's Hospital, and 5′4, 5′10, 6′2 from the Adults Hospital) and does not receive any information regarding the units of measurements of those respective data streams or their distributions. In some embodiments, the unit conversion module 200 is trained to convert the numerical data streams 212 into the same units of measurement prior to storage in the combined data warehouse 208. Training of the unit conversion module 200 is discussed in greater detail with respect to FIG. 3.

FIG. 3 depicts a block diagram of an example training process 300 for a unit conversion module (e.g., the unit conversion module 200 of FIG. 1) in accordance with one or more embodiments of the present invention. Consider an example scenario in which D is the union of N disjoint measurement sources (i.e., D=D₁ U D₂ U. . . . U D_{N}) and that each of the N measurement sources used different, unknown units. Consider further that the data provided by each of the N measurement sources have different distributions (e.g., adult heights vs. children heights, women blood pressure vs. men blood pressure, etc.) and that no other background knowledge about the data is provided, other than the values of the measurements (i.e., the numerical values of the data).

Continuing with the prior example, assume that D₁ (“Hospital 1: General Hospital”) is chosen as the target data source, perhaps because D₁ is a relatively large data set with a representative population (e.g., height and cholesterol data are provided for a varied population of men, women, and children). The unit of the measurements for D₁ can be either known or unknown. In some embodiments, optional contextual category variables define a specific sub-population for each measurement in D₁, such as, for example, Z={Women, Men, Children}.

Observe that, if the measurement data from the children and adult hospitals (e.g., Hospital 2 and Hospital 3 in FIG. 2) are expressed using the same units as the measurement data from D₁ (here, the general hospital), then the distribution of the combined data should be very similar to the distribution of the general hospital. In some embodiments, the example training process 300 includes learning N−1 conversion functions, one for each measurement type (e.g., heights) from each other data source (e.g., the Children's Hospital and Adult's Hospital), such that the distribution of the combined converted height data is statistically similar to the distribution of the general hospital height data. As used herein, “statistically similar” means that a statistical difference or distance between two values is below a predetermined metric, such as, for example, within 1 percent, or 3 percent, or 5 percent, etc.

Continuing from the prior example, consider a scenario in which the unit conversion module 200 is tasked to automatically convert height and cholesterol measurements in different unknown units form the Children's Hospital and the Adult's Hospital to the same (possibly also unknown) units of the data in the General Hospital. To accomplish this task, the unit conversion module 200 is trained using the training process 300. In some embodiments, the training process 300 includes two steps.

Step 1: pre-train a generative model G on a selected target stream of data (here, data from D₁). The particular type of generative model G is not meant to be particularly limited and can include, for example, a VAE, a Generative Adversarial Network (GAN), and/or a sequence generative model such as a Long Short-Term Memory network (LSTM), transformer, etc. In some embodiments, such as when the generative model G is a sequence generative model configured to handle temporal dependencies, the input (i.e., the target stream of data) can further include additional data, such as, for example, timestamps. In some embodiments, G is trained to estimate a true distribution G(D)=P(D) of the input data from D₁ in a unit of interest.

If contextual information is available in the target source D₁, such as a data label for the population category of each measurement that partitions D₁ into two or more sub-populations (e.g., Children, Men, Women) defined by a contextual category variable (e.g., C, M, W, etc.), then a separate generative model Gᵢ is trained for each of the sub-populations to estimate a conditional distribution Gᵢ(D)=P(D|z), where z is the respective contextual category variable.

In some embodiments, the entirety of the input data from D₁ is used as training data to train the generative model G. In some embodiments, a first subset of the input data from D₁ is used as training data to train the generative model G, and a second, reserved subset of the input data from Dᵢ is used as test data for G after training.

Step 2: train N−1 conversion neural networks {C₂, . . . . CN} (referred to as conversion nets) for each of the other (non-target) data sources. In some embodiments, each conversion net Cᵢ takes as input the data from a respective one of the other, non-target data sources. For example, the conversion net C₂ can take as input the measurement data (e.g., heights) from D₂. The particular type of neural network selected for the conversion nets Cᵢ is not meant to be particularly limited. In some embodiments, each of the conversion nets is a multi-layer perceptron with linear hidden layers and nonlinear activation functions, such as, for example, a Rectified Linear Unit (ReLU), a Hyperbolic Tangent Function (Tanh), etc. In some embodiments, such as when the generative model G is a sequence generative model configured to handle temporal dependencies, the input to the conversion net(s) also includes additional data, such as, for example, the timestamps provided during Step 1, to ensure consistency with the distribution learned using the generative model G (e.g., LSTM, transformers, etc.). In other words, in embodiments where the generative model G is a sequence generative model configured to handle temporal dependencies, such as an LSTM and/or transformer (i.e., when the data used for learning/training G has temporal order), the conversion net(s) will also include an architecture to handle temporal orders, such as, for example, transformers and/or LSTM.

In some embodiments, each of the conversion nets Cᵢ is trained to approximate a conversion function that includes a linear and/or a non-linear transformation of the input data that converts the input data to the expected (possibly unknown) unit of the target source using an optimization objective. That is, each conversion net is trained to output converted data Cᵢ(Dᵢ), with i=2, 3, . . . , N, such that, when fed to the pre-trained generative model G, the converted data Cᵢ(Dᵢ) approximates the distribution in D₁ (i.e., P(Cᵢ(Dᵢ)) or P(Cᵢ(Dᵢ)|zᵢ), where P(.) is the distribution learned from Dᵢ using the generative model G.

In some embodiments, the optimization objective depends on whether contextual information z (refer to Step 1) is available for the converted data Cᵢ(Dᵢ). If the combined converted data Cᵢ(Dᵢ) for all i=2, 3, . . . , N should follow the same distribution as the general data distribution (e.g., the combined converted measurements from the Adult's Hospital and the Children's Hospital should follow the same distribution of the data from the General Hospital), then the training objective is to minimize the negative log-likelihood of the general distribution according to equation (1).

$$- {\sum }_{i = 2}^{N} log ( P ( G ( C i ( D i ) ) ) ) \qquad ( 1 )$$

In other words, input data Dₘ is converted by Cₘ such that the converted data follows the same distribution of the general data in the target source (here, D₁).

Alternatively, if the combined data Cᵢ(Dᵢ) for all i=2, 3, . . . , N is only a part of the entire data from the target data source (e.g., data is sourced from a Women's Hospital and a Children's Hospital, but adult male patient data is missing), then the training objective is to minimize the negative log-likelihood of the conditional distribution of data in each category defined by a contextual category variable according to equation (2).

$$- {\sum }_{i = 2}^{N} log ( P ( G ( C i ( D i ) ) \vert zi ) ) \qquad ( 2 )$$

In other words, input data Dₘ is converted by Cₘ such that the converted data follows the same distribution of the portion of the general data in the target source (here, D₁) having the same contextual category (e.g., the conversion net for data from a Children's hospital is trained to match the distribution of the subset of D₁ including patient data for children).

Advantageously, the conversion nets can learn linear or non-linear transformations. Moreover, training the generative model G and the conversion nets Cᵢ in this manner enables a native end-to-end, completely differentiable conversion of measurement units from only numerical input data (i.e., without knowing, a priori, the measurement units and/or their distribution).

Moreover, while aspects of the present disclosure are generally described with respect to embodiments where a master data source is selected (e.g., D₁ above), such a configuration is not strictly required. In some embodiments, a “test” Dᵢ can be provisionally selected as a “master data source” and the objective function can be calculated as described herein (refer to equations (1) or (2)). The process can then be repeated arbitrarily with a new “test” Dᵢ each time, and the respective objection functions can be evaluated. In some embodiments, the “test” Dᵢ having the highest objective function performance can be selected as the “final” master source and the process can then proceed as previously described (i.e., via Step 1 and Step 2).

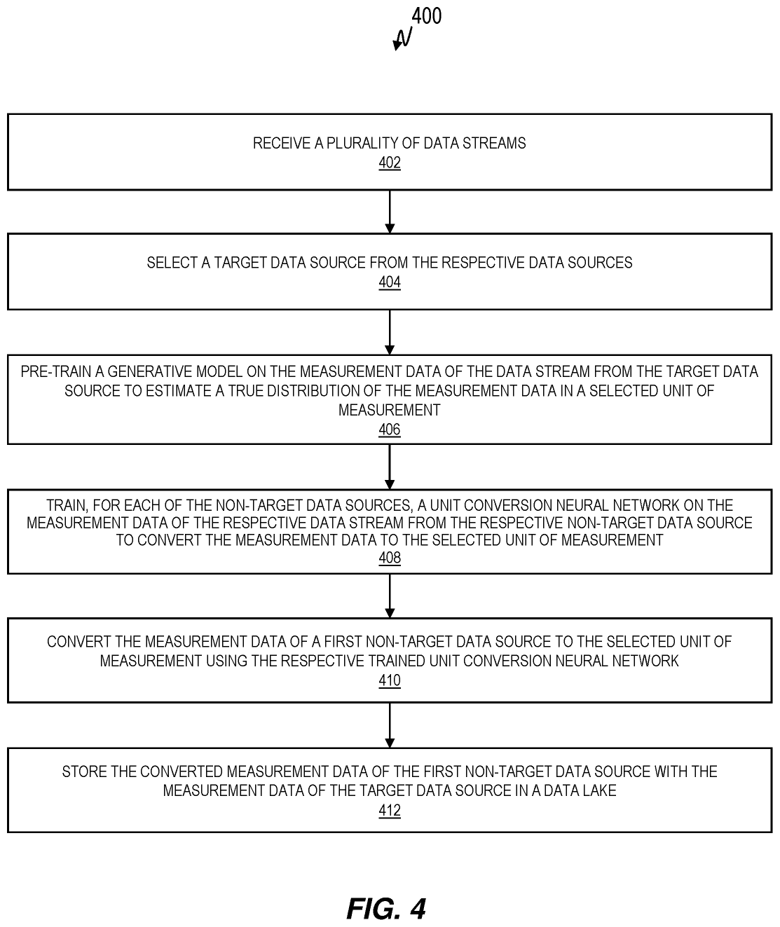

Referring now to FIG. 4, a flowchart 400 for automatically converting measurements from measurement sources having different units is generally shown according to an embodiment. The flowchart 400 is described in reference to FIGS. 1-3 and may include additional blocks not depicted in FIG. 4. Although depicted in a particular order, the blocks depicted in FIG. 4 can be rearranged, subdivided, and/or combined.

At block 402, a plurality of data streams are received. In some embodiments, each data stream is received from a respective data source and includes a plurality of measurement data. In some embodiments, each data stream includes a numerical data stream that includes a value for a measurement but does not include a unit of measurement for the value.

At block 404, a target data source is selected from the respective data sources. The remaining (non-selected) data sources define non-target data sources.

At block 406, a generative model is pre-trained on the measurement data of the data stream from the target data source to estimate a true distribution of the measurement data in a selected unit of measurement. In some embodiments, the generative model includes one or more of a VAE, a GAN, and a sequence generative model including one of an LSTM and a transformer.

In embodiments where contextual information is available in the data stream from the target data source that partitions the target data source into two or more sub-populations, pre-training the generative model includes training a separate generative model for each of the sub-populations to estimate a conditional distribution of the respective sub-population. In other embodiments (i.e., where contextual information is not available), pre-training the generative model includes estimating the true distribution of the measurement data in the target data source.

In some embodiments, an entirety of the measurement data of the data stream from the target data source is used as training data to pre-train the generative model. In some embodiments, a portion (but not all) of the measurement data of the data stream from the target data source is used as training data to pre-train the generative model.

At block 408, a unit conversion neural network is trained for each of the non-target data sources. In some embodiments, each of the unit conversion neural networks includes a multi-layer perceptron with linear hidden layers and nonlinear activation functions.

Each unit conversion neural network is trained on the measurement data of the respective data stream from the respective non-target data source to convert the measurement data to the selected unit of measurement. In some embodiments, training each unit conversion neural network includes approximating a conversion function such that a distribution of the measurement data from the respective non-target data source matches a distribution of the measurement data from the target data source.

In some embodiments (i.e., those having contextual data), training each unit conversion neural network further includes approximating the conversion function such that the distribution of the measurement data from the respective non-target data source matches a distribution of a sub-population of the measurement data from the target data source that matches a sub-population of the measurement data from the respective non-target data source.

At block 410, the measurement data of a first non-target data source is converted to the selected unit of measurement using the respective trained unit conversion neural network.

At block 412, the converted measurement data of the first non-target data source is stored with the measurement data of the target data source in a data lake.

Technical advantages and benefits include the automatic conversion of data at the value level, as opposed to the format level. Conversion systems built according to one or more embodiments can automatically harmonize data from a variety of sources, but, unlike prior approaches, can do so without requiring any predetermined data format or representation schema, and without even requiring that the underlying data formats and distributions be known. Other advantages are possible.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

One or more of the methods described herein can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description, but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The present invention may be a system, a method, and/or a computer program product at any possible technical detail level of integration. The computer program product may include a computer readable storage medium (or media) having computer readable program instructions thereon for causing a processor to carry out aspects of the present invention.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method comprising:
receiving a plurality of data streams, each data stream received from a respective data source and comprising a plurality of measurement data;
selecting a target data source from the respective data sources, wherein remaining data sources comprise non-target data sources;
pre-training a generative model on the measurement data of the data stream from the target data source to estimate a true distribution of the measurement data in a selected unit of measurement;
training, for each of the non-target data sources, a unit conversion neural network on the measurement data of the respective data stream from the respective non-target data source to convert the measurement data to the selected unit of measurement, wherein training each unit conversion neural network comprises approximating a conversion function such that a distribution of the measurement data from the respective non-target data source matches a distribution of the measurement data from the target data source;
converting the measurement data of a first non-target data source to the selected unit of measurement using the respective trained unit conversion neural network; and
storing the converted measurement data of the first non-target data source with the measurement data of the target data source in a data lake.

2. The computer-implemented method of claim 1, wherein each data stream comprises a numerical data stream that includes a value for a measurement but does not include a unit of measurement for the value.

3. The computer-implemented method of claim 1, wherein selecting the target data source from the respective data sources comprises:
provisionally selecting two or more data sources and, for each provisionally selected data source, determining an objective function evaluation; and
selecting the provisionally selected data source having a highest objective function performance as the target data source.

4. The computer-implemented method of claim 1, wherein, if contextual information that partitions the target data source into two or more sub-populations is available in the data stream from the target data source, pre-training the generative model comprises training a separate generative model for each of the sub-populations to estimate a conditional distribution of the respective sub-population.

5. The computer-implemented method of claim 4, wherein training each unit conversion neural network further comprises approximating the conversion function such that the distribution of the measurement data from the respective non-target data source matches a distribution of a sub-population of the measurement data from the target data source that matches a sub-population of the measurement data from the respective non-target data source.

6. The computer-implemented method of claim 1, wherein each of the unit conversion neural networks comprises a multi-layer perceptron with linear hidden layers and nonlinear activation functions.

7. The computer-implemented method of claim 1, wherein an entirety of the measurement data of the data stream from the target data source is used as training data to pre-train the generative model.

8. A system having a memory, computer readable instructions, and one or more processors for executing the computer readable instructions, the computer readable instructions controlling the one or more processors to perform operations comprising:
receiving a plurality of data streams, each data stream received from a respective data source and comprising a plurality of measurement data;
selecting a target data source from the respective data sources, wherein remaining data sources comprise non-target data sources;
pre-training a generative model on the measurement data of the data stream from the target data source to estimate a true distribution of the measurement data in a selected unit of measurement;
training, for each of the non-target data sources, a unit conversion neural network on the measurement data of the respective data stream from the respective non-target data source to convert the measurement data to the selected unit of measurement, wherein training each unit conversion neural network comprises approximating a conversion function such that a distribution of the measurement data from the respective non-target data source matches a distribution of the measurement data from the target data source;
converting the measurement data of a first non-target data source to the selected unit of measurement using the respective trained unit conversion neural network; and
storing the converted measurement data of the first non-target data source with the measurement data of the target data source in a data lake.

9. The system of claim 8, wherein each data stream comprises a numerical data stream that includes a value for a measurement but does not include a unit of measurement for the value.

10. The system of claim 8, wherein selecting the target data source from the respective data sources comprises:
provisionally selecting two or more data sources and, for each provisionally selected data source, determining an objective function evaluation; and
selecting the provisionally selected data source having a highest objective function performance as the target data source.

11. The system of claim 8, wherein, if contextual information that partitions the target data source into two or more sub-populations is available in the data stream from the target data source, pre-training the generative model comprises training a separate generative model for each of the sub-populations to estimate a conditional distribution of the respective sub-population.

12. The system of claim 11, wherein training each unit conversion neural network further comprises approximating the conversion function such that the distribution of the measurement data from the respective non-target data source matches a distribution of a sub-population of the measurement data from the target data source that matches a sub-population of the measurement data from the respective non-target data source.

13. The system of claim 8, wherein each of the unit conversion neural networks comprises a multi-layer perceptron with linear hidden layers and nonlinear activation functions.

14. The system of claim 8, wherein an entirety of the measurement data of the data stream from the target data source is used as training data to pre-train the generative model.

15. A computer program product comprising a computer readable storage medium having program instructions embodied therewith, the program instructions executable by one or more processors to cause the one or more processors to perform operations comprising:
receiving a plurality of data streams, each data stream received from a respective data source and comprising a plurality of measurement data;
selecting a target data source from the respective data sources, wherein remaining data sources comprise non-target data sources;
pre-training a generative model on the measurement data of the data stream from the target data source to estimate a true distribution of the measurement data in a selected unit of measurement;
training, for each of the non-target data sources, a unit conversion neural network on the measurement data of the respective data stream from the respective non-target data source to convert the measurement data to the selected unit of measurement, wherein training each unit conversion neural network comprises approximating a conversion function such that a distribution of the measurement data from the respective non-target data source matches a distribution of the measurement data from the target data source;
converting the measurement data of a first non-target data source to the selected unit of measurement using the respective trained unit conversion neural network; and
storing the converted measurement data of the first non-target data source with the measurement data of the target data source in a data lake.

16. The computer program product of claim 15, wherein each data stream comprises a numerical data stream that includes a value for a measurement but does not include a unit of measurement for the value.

17. The computer program product of claim 15, wherein selecting the target data source from the respective data sources comprises:
provisionally selecting two or more data sources and, for each provisionally selected data source, determining an objective function evaluation; and
selecting the provisionally selected data source having a highest objective function performance as the target data source.

18. The computer program product of claim 15, wherein, if contextual information that partitions the target data source into two or more sub-populations is available in the data stream from the target data source, pre-training the generative model comprises training a separate generative model for each of the sub-populations to estimate a conditional distribution of the respective sub-population.

19. The computer program product of claim 18, wherein training each unit conversion neural network further comprises approximating the conversion function such that the distribution of the measurement data from the respective non-target data source matches a distribution of a sub-population of the measurement data from the target data source that matches a sub-population of the measurement data from the respective non-target data source.

20. The computer program product of claim 15, wherein each of the unit conversion neural networks comprises a multi-layer perceptron with linear hidden layers and nonlinear activation functions.
